(19) United States
(12) Patent Application Publication
(10) Pub. No.: US 2008/0265565 A1
(43) Pub. Date: Oct. 30, 2008

(54) SUCTION COUPLING SYSTEM AND ASSEMBLY

(75) Inventors: Dean E. Sitz, Wahpeton, ND (US); Chad L. Portscheller, Wahpeton, ND (US); Trevor J. Stav, Wahpeton, ND (US)

Correspondence Address: DICKE, BILLIG & CZAJA, FIFTH STREET TOWERS, 100 SOUTH FIFTH STREET, SUITE 2250, MINNEAPOLIS, MN, 55402, US

(73) Assignee: COMDEL INNOVATIONS INC., Wahpeton, ND (US)

(21) Appl. No.: 12/110,488

(22) Filed: Apr. 28, 2008

Related U.S. Application Data
(60) Provisional application No. 60/926,308, filed on Apr. 26, 2007.

(51) Int. Cl. F16L 17/06; F16L 25/04

(52) U.S. Cl. 285/98; 285/331

(57) ABSTRACT

A suction coupling includes a first union coupled to a second union. The first union includes a first tubing joint extending from a side of the first union and a male flange extending from an end of the first union. The second union includes a second tubing joint extending from a side of the second union and defines a female receptacle formed in an open end of the second union. The male flange is rotatably coupled with the female receptacle such that when suction is applied to the second union, the first union forms a liquid seal relative to the second union.

### CROSS-REFERENCE TO RELATED APPLICATION

This Non-Provisional patent application claims the benefit of the filing date of U.S. Provisional Patent Application Ser. No. 60/926,308 filed Apr. 26, 2007, entitled “SUCTION COUPLING AND ASSEMBLY.”

### BACKGROUND

Suction devices generally include a suction source and some form of tubing coupled between the suction source and the suction device. When using the suction device, the operator typically moves the suction device from one area of interest to another area of interest. The movement of the suction device has the potential to tangle the suction tubing and possibly impinge the tubing, thus reducing suction. In addition, the movement of the suction device has the potential to tug components of the suction device apart and possibly disengage the tubing from the device. When the suction source is a high vacuum source such as is employed with ultrasonic dental cleaning, the weight and inflexibility of the tubing has the potential to fatigue and possibly cause strain to the operator's wrist and arms.

It is desirable to provide improvements to suction device assemblies that minimize tubing tangling, device disengagement, and user fatigue.

### SUMMARY

One aspect provides a suction coupling including a first union coupled to a second union. The first union includes a first tubing joint extending from a side of the first union and a male flange extending from an end of the first union. The second union includes a second tubing joint extending from a side of the second union and defines a female receptacle formed in an open end of the second union. The male flange is rotatably coupled with the female receptacle such that when suction is applied to the second union, the first union forms a liquid seal relative to the second union.

Another aspect provides a suction coupling including a first union coupled to a second union. The first union includes a first tubing joint in fluid communication with a male flange extending from an end of the first union, the male flange including a circumferential seal disposed at a base and a circumferential ridge adjacent to a leading end of the male flange. The second union includes a second tubing joint in fluid communication with a female receptacle formed in an open end of the second union. The female receptacle defines an internal circumferential sealing surface formed adjacent to the open end, a circumferential base formed inside the female receptacle between the internal circumferential sealing surface and the tubing joint, and a peripheral trough formed adjacent to the circumferential base. The circumferential ridge of the male flange is rotatably disposed within the peripheral trough of the female receptacle and the circumferential sealing surface of the female receptacle seals against the circumferential seal of the male flange.

Another aspect provides a suction coupling system including a handheld suction device, a first union coupled to the handheld suction device, a second union coupled to the first union, and suction source tubing in fluid communication with the second union. The first union includes a first tubing joint in fluid communication with the handheld suction device and a male flange that extends from an end of the first union, the male flange including a circumferential seal disposed at a base and a circumferential ridge adjacent to a leading end of the male flange. The second union includes a second tubing joint in fluid communication with a female receptacle formed in an open end of the second union. The female receptacle defines an internal circumferential sealing surface formed adjacent to the open end, a circumferential base formed inside the female receptacle between the internal circumferential sealing surface and the tubing joint, and a peripheral trough formed adjacent to the circumferential base. The suction source tubing is in fluid communication with the second tubing joint. The circumferential ridge of the male flange is rotatably disposed within the peripheral trough of the female receptacle and the circumferential sealing surface of the female receptacle seals against the circumferential seal of the male flange.

### BRIEF DESCRIPTION OF THE DRAWINGS

The accompanying drawings are included to provide a further understanding of the disclosure and are incorporated in as a part of this specification. The drawings illustrate example embodiments and together with the description serve to explain principles of the invention. Other embodiments and many of the intended advantages of the embodiments will be readily appreciated as they become better understood by reference to the following detailed description. The elements of the drawings are not necessarily to scale relative to each other. Like reference numerals designate corresponding similar parts.

FIG. 1 is a perspective view of a suction assembly including a suction coupling attached between suction source tubing and a suction device according to one embodiment;

FIG. 2A is a perspective view of a male union of the suction coupling shown in FIG. 1;

FIG. 2B is a cross-sectional view of a female union of the suction coupling shown in FIG. 1;

FIG. 3A is a side view of the suction assembly shown in FIG. 1;

FIG. 3B is a partial cross-sectional view of the suction assembly shown in FIG. 3A;

FIG. 3C is a cross-sectional view of the suction assembly shown in FIG. 3A;

FIG. 3D is an enlarged cross-sectional view of a portion of the suction coupling shown in FIG. 3C;

FIG. 4 is a perspective view of another suction assembly according to one embodiment;

FIG. 5 is a perspective view of the suction assembly shown in FIG. 4 hung on a tray according to one embodiment;

FIG. 6 is a partially exploded perspective view of a suction coupling system according to one embodiment; and

FIG. 7 is a cross-sectional view of an axial suction coupling of the system shown in FIG. 6.

### DETAILED DESCRIPTION

In the following Detailed Description, reference is made to the accompanying drawings which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

Embodiments provide a suction coupling spliced between ends of suction tubing that enables free, rotational use of a handheld device coupled to one end of the tubing in a manner that minimizes kinking of the tubing and user fatigue.

Embodiments provide a suction coupling including a first union coupled to a second union, where the first union is fully rotatable through 360 degrees relative to the second union. In addition, when suction is applied to the second union, the first union is drawn or forced into the second union to provide an improved liquid seal relative to the second union.

Other embodiments provide a suction coupling system including a handheld suction device coupled to a first union, where the first union is coupled to a second union that is in fluid communication with suction source tubing. In one embodiment, the first union is fully rotatable through 360 degrees relative to the second union. In another embodiment, the suction coupling system includes an axial suction coupling disposed between opposed spliced ends of the suction source tubing such that the first union rotates relative to the second union about a first axis and the axial suction coupling is configured to enable the suction source tubing to rotate about a second axis different from the first axis.

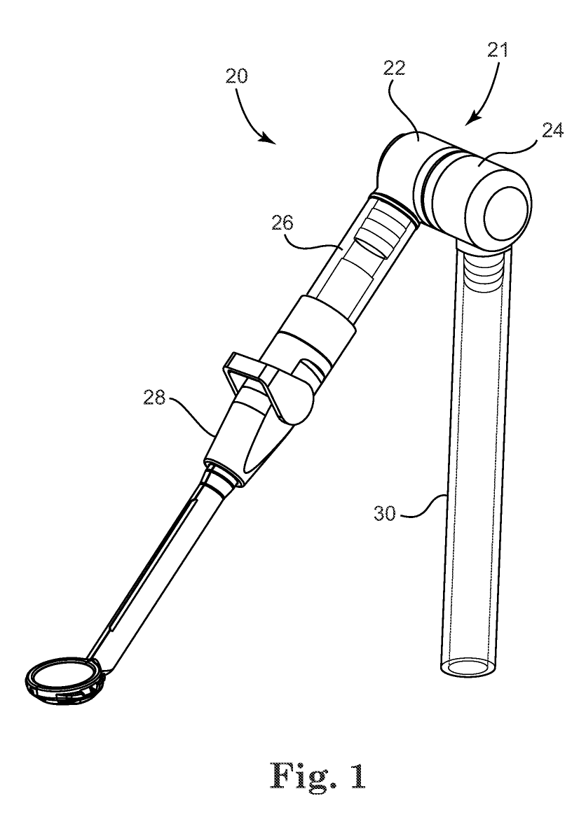

FIG. 1 is a perspective view of a suction assembly 20 according to one embodiment. The suction assembly 20 includes a suction coupling 21 having a first union 22 coupled to a second union 24, suction tubing 26 coupled between the first union 22 and a suction device 28, and suction tubing 30 coupled between the second union 24 and a suction source (not shown). In one embodiment, the first union 22 is a male union and the second union 24 is a female union, although other configurations are acceptable. The suction assembly 20 is compatible with any suction source, including high vacuum sources as are employed with ultrasonic dental cleaning systems. The suction coupling 21 is configured to enable the suction device 28 to be moved freely and independently relative to the suction tubing 30 to minimize the arm/hand strain of an operator during use of the suction device 28.

In one embodiment, first union 22 provides a liquid seal when coupled to second union 24, and the first union 22 freely rotates relative to second union 24 such that suction device 28 can be moved without substantially moving tubing 30 coupled to suction source. In this manner, suction coupling 21 provides an additional degree of freedom to the suction tubing 26, 30 and enables the suction device 28 to be moved without the resistance that is associated with “pulling the tubing along.” The suction device 28 is more easily maneuvered, and the stress of pulling the suction tubing 30 along with the device 28 is minimized. The suction coupling 21 is thus configured to enable the tubing 30 to drape behind the device 28 in a “natural” and relaxed manner that minimizes or reduces the fatigue on the hand/arm of the user.

In one embodiment, the suction source provides a vacuum ranging from about 5-15 inches Hg. The tubing 26, 30 includes high suction tubing employed in dental offices, low suction tubing, or Tygon plastic tubing available from Polymer Plastics Corp., Reno, Nev. One example of suitable tubing includes asepsis dental tubing available from KAB Dental, Sterling Heights, Mich. The suction device 28 includes general suction devices, hazardous waste suction devices, particle suction devices, liquid suction devices, and dental suction devices, such as ULTRAVIEW® available from DentaVations, Inc., Fargo, N. Dak. Other forms of tubing, and other suction devices, are also acceptable.

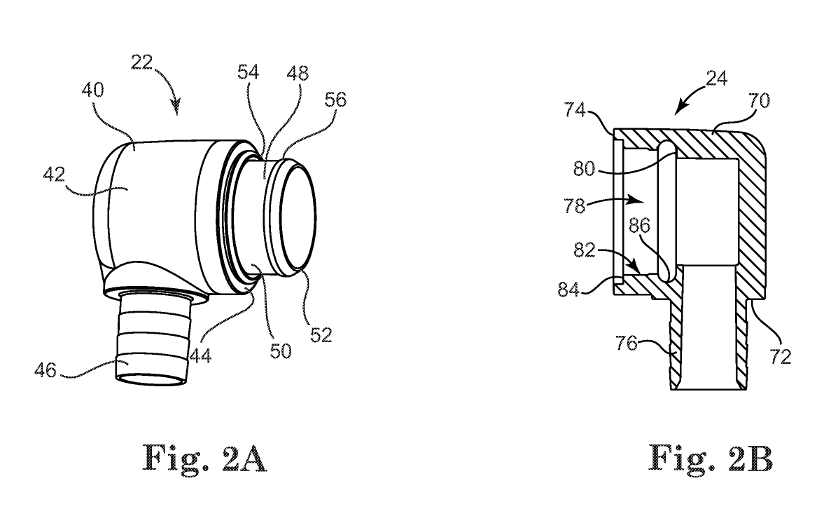

FIG. 2A is a perspective view of the male first union 22. In one embodiment, the first union 22 includes a first housing 40 defining a housing side 42 and an end 44, a tubing joint 46 extending from the side 42, and a male flange 48 extending form the end 44. In one embodiment, the tubing joint 46 includes a positive attach feature configured to grip the tubing to which it is coupled, such as the barbs shown. In one embodiment, the male flange 48 is in fluid communication with the tubing joint 46, and the male flange 48 is oriented in a substantially orthogonal manner relative to the tubing joint 46.

In one embodiment, the male flange 48 extends between a base portion 50 coupled to the end 44 and a leading end 52. In one embodiment, an O-ring 54 is coupled about the male flange 48 adjacent the base portion 50, and an annular or circumferential ridge 56 is formed around the male flange 48 adjacent the leading end 52. In one embodiment, the O-ring 54 is a high-temperature Viton® O-ring that is suitable for autoclaving, one source for which includes United States Plastic Corp., Lima, Ohio.

FIG. 2B is a cross-sectional view of the female second union 24. The second union 24 includes a second housing 70 having a housing side 72 and an open end 74, a tubing joint 76 extending from the housing side 72, and a female receptacle 78 formed in the open end 74. In one embodiment, the tubing joint 76 includes a positive attach feature configured to grip the tubing to which it is coupled, such as the barbs shown. In one embodiment, the tubing joint 76 is in fluid communication with the female receptacle 78, where the tubing joint 76 is oriented at a substantially right angle relative to the female receptacle 78, although other angles, such as including the tubing joint 76 aligned with the female receptacle 78 are also acceptable.

In one embodiment, the female receptacle 78 defines an annular or circumferential base 80 formed within the second housing 70 and an annular or circumferential channel 82 that extends to the open end 74. In one embodiment, an recessed peripheral sealing surface 84 is formed within the female receptacle 78 adjacent to the open end 74, and a peripheral trough 86 is formed within the female receptacle 78 adjacent to the base 80.

The female receptacle 78 is configured to receive the male flange 48. With additional reference to FIG. 2A, when the first union 22 is coupled to the second union 24, the leading end 52 of the male flange 48 is inserted against the base 80, the trough 86 receives the ridge 56, and the O-ring 54 sealingly couples with the peripheral sealing surface 84. In this manner, the first union 22 is sealed to the second union 24 in a manner that provides a fluid seal and enables rotation of the first union 22 relative to the second union 24. In one embodiment, the O-ring 54 provides one means for viscously coupling the first union 22 to the second union 24. When so coupled, the unions 22, 24 are fully rotatable through 360 degrees relative to each other.

The suction coupling 21 (FIG. 1) is fabricated from a material suited to the end use, such as metal or plastic. In one embodiment, the suction coupling 21 is fabricated from nylon or a polyolefin or other suitable plastic. Suitable plastics for suction coupling 21 include thermoplastic Acetal, nylon, nylon 6, nylon 6,6, polyetherimide, and polyolefins such as high density polyethylene, polypropylene, polyester, and acrylonitrile-butadiene-styrene (ABS). As an example, at least the nylon and polyetherimide plastics are autoclavable. Other suitable non-leaching and non-corrosive materials are also acceptable for fabricating suction coupling 21.

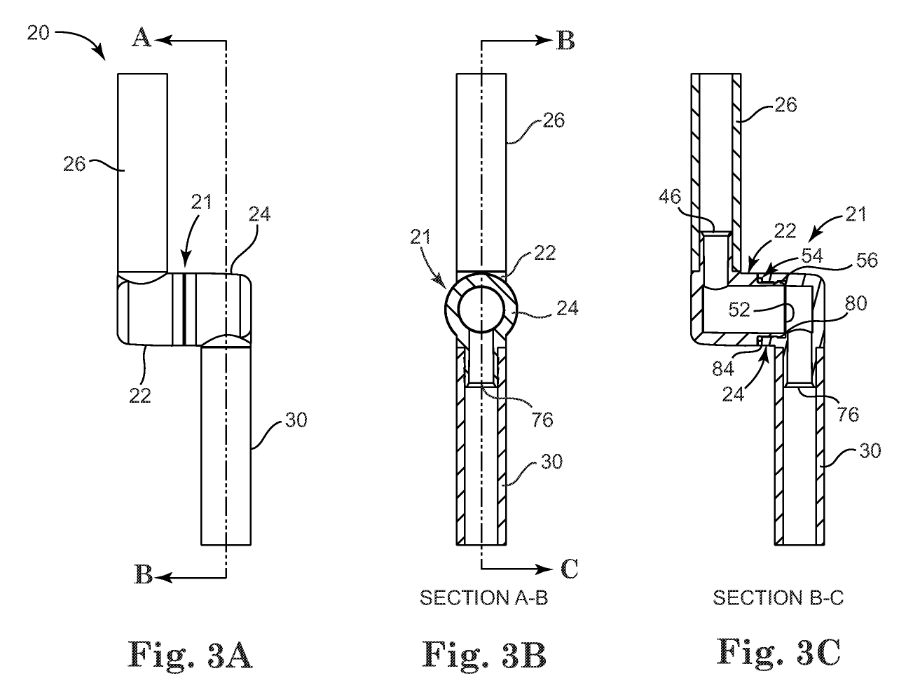

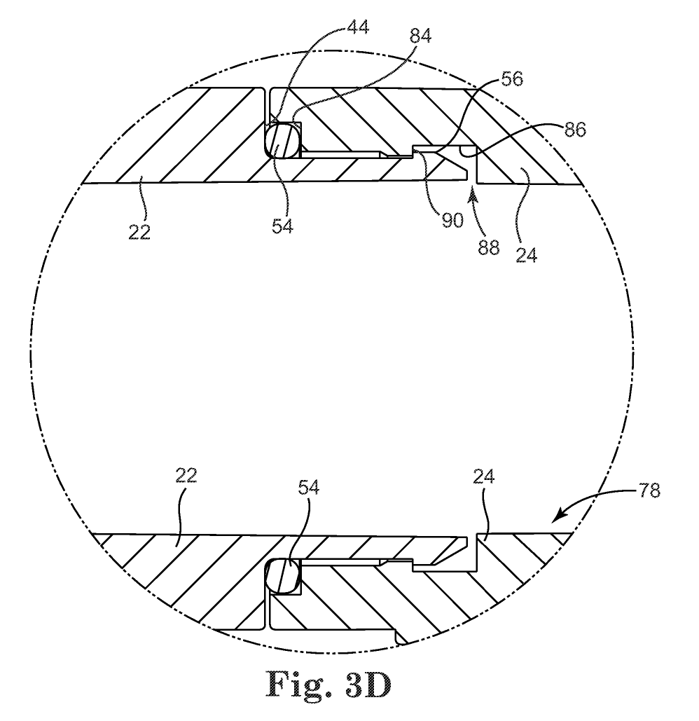

FIG. 3A is a side view of the suction assembly 20. The suction tubing 26 extends away from the first union 22 and the tubing 30 that couples with the suction source extends away from the second union 24. The first union 22 seals against the second union 24 and is configured to rotate 360 degrees relative to the second union 24.

FIG. 3B is a partial cross-sectional view of the suction assembly 20 taken along section A-B of FIG. 3A. The tubing joint 76 of the second union 24 is sealed against and coupled to an inside diameter of the tubing 30. The first union 22 is illustrated in the background and is connected to the suction tubing 26.

FIG. 3C is a cross-sectional view of the suction assembly 20 taken along section B-C of FIG. 3A, and FIG. 3D is an enlarged view of the suction coupling 21. The tubing joint 46 is sealed against and coupled to an inside diameter of the suction tubing 26. The male flange 48 is inserted into and coupled with the female receptacle 78. The leading end 52 of the male flange 48 is offset from the base 80 formed in the female receptacle 78 to provide a clearance 88 between the union 22 and the union 24. The ridge 56 engages with a ridge 90 of the trough 86 of the female receptacle 78. The O-ring 54 is sealed between the end 44 of the first union 22 and the peripheral sealing surface 84 of the second union 24. In this manner, the first union 22 is configured to rotate relative to the second union 24, and the suction coupling 21 is sealed to prevent leakage of liquids through the coupling 21. The suction tubing 26 is in fluid communication with the first union 22, which is in fluid communication with the second union 24 and the tubing 30. In one embodiment, clearance 88 is configured to be a zero clearance such that leading end 52 of the male flange 48 seals against the base 80 formed in the female receptacle 78.

The ridge 56 and the trough 86 combine to define one means for rotatably coupling the first union 22 to the second union 24 in a liquid-sealed manner. The O-ring 54 and the peripheral sealing surface 84 combine to define one means for rotatably coupling the first union 22 to the second union 24 in a liquid-sealed manner. The O-ring 54 and the peripheral sealing surface 84 combine to define one means forming a viscous coupling between the first union 22 and the second union 24. When suction is present, the male flange 48 of the first union 22 is drawn into the second union 24. In this manner, the suction coupling 21 is drawn into an even more tightly sealed leak-free configuration, and yet allows first union 22 to rotate and move relative to the second union 24.

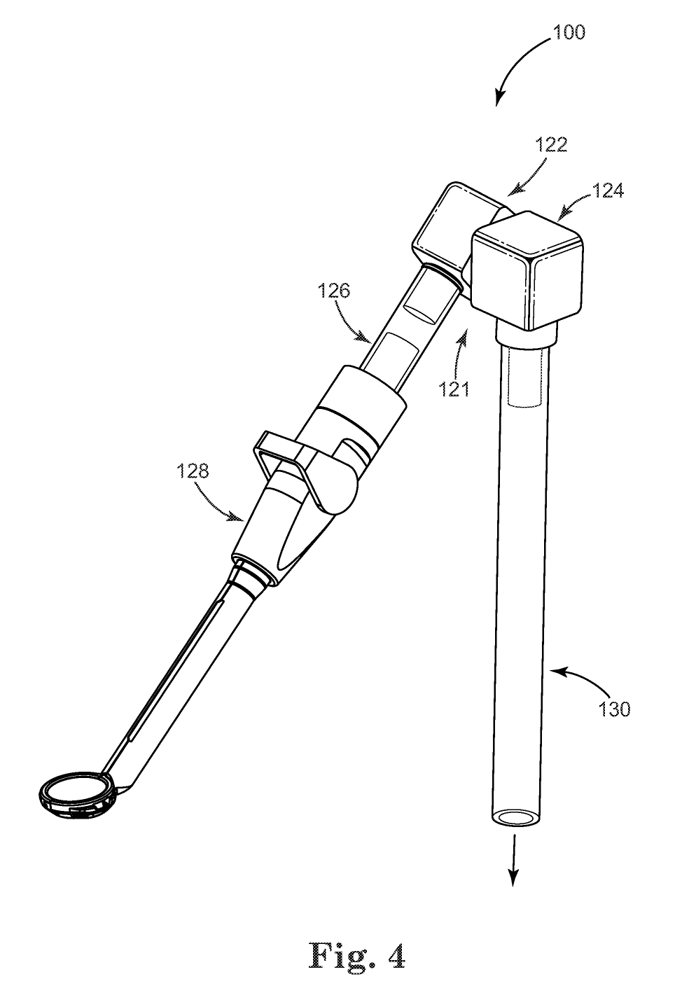

FIG. 4 is a perspective view of another suction assembly 100 according to one embodiment. The suction assembly 100 includes a suction coupling 121 including a first union 122 coupled to a second union 124, suction tubing 126 coupled between first union 122 and a suction device 128, and suction tubing 130 coupled to the second union 124 and a suction source (not shown). In one embodiment, the first union and the second union 124 engage with one another in a manner that enables the first union 122 to rotate relative to the second union 124. In one embodiment, the first union 122 is similar to the first union 22 (FIG. 2) and the second union 124 is similar to the second union 24 (FIG. 2). In one embodiment, the first union 122 defines a cube-shape and the second union 124 defines a complementary cube-shape. In this regard, the exterior housing shape of the unions 122, 124 can include a variety of shapes.

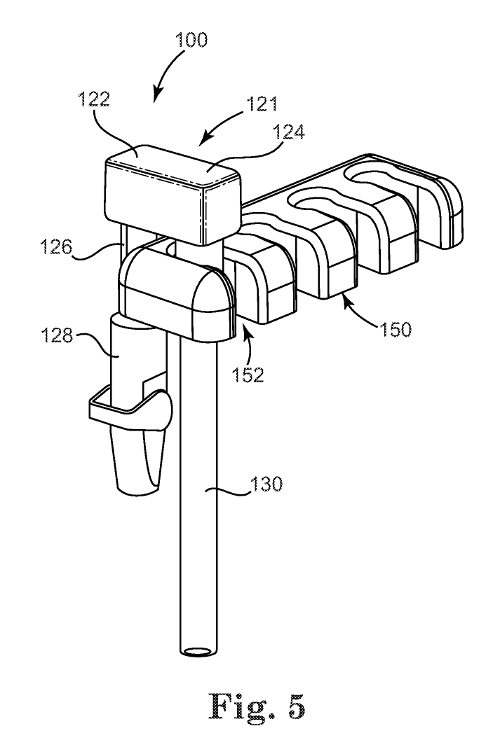

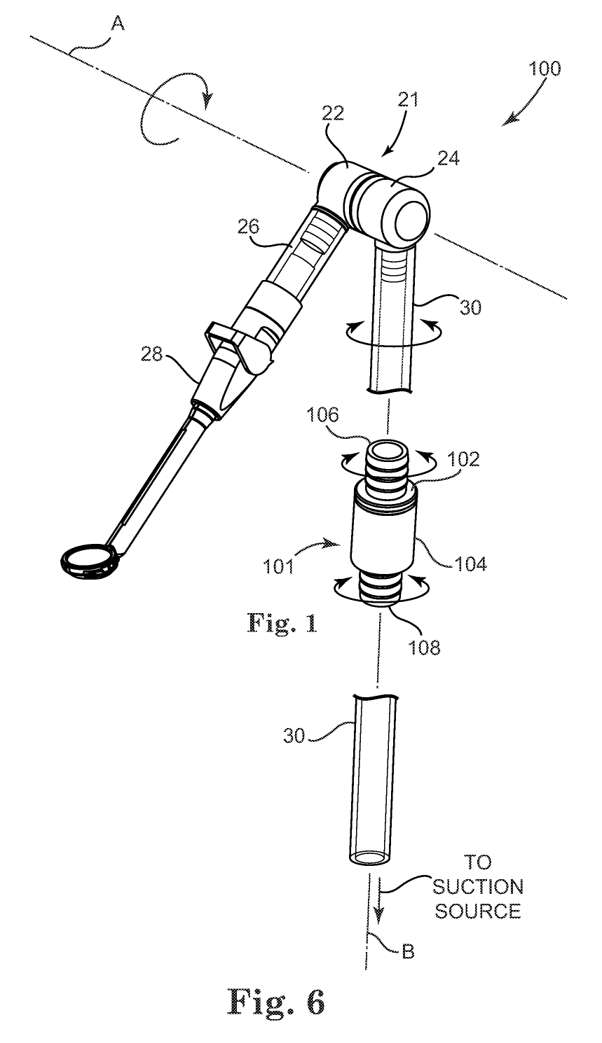

FIG. 5 illustrates a perspective view of the suction assembly 100 hung on a tray 150 according to one embodiment. In one embodiment, the first union 122 is swiveled relative to the second union 124 such that the suction coupling 121 and the tubes 126, 130 define a substantially U-shaped assembly suited for hanging in a slot 152 of the tray 150. When deployed for use, the suction coupling 121 is lifted from the slot 152, and the first union 122 rotates relative to the second union 124 such that the suction assembly 100 elongates to a substantially linear configuration. In this manner, the suction assembly 100 may be removed from the slot 152 and flexed for use in various suction procedures.

In another embodiment, the suction assembly 100 is hung in a vertical manner from the tray 150. For example, the first union 122 is swiveled relative to the second union 124 such that the suction coupling 121 and the tubes 126, 130 are substantially aligned in a linear manner, and the suction device 128 is coupled into the slot 152. To this end, the suction device 128 is oriented in an up position in a manner that minimizes the potential for liquid to undesirably drip from the suction device 128 onto the floor.

FIG. 6 is a partially exploded perspective view of a suction coupling system 100 according to one embodiment. Suction coupling system 100 (system 100) includes the assembly 20 (FIG. 1) described above and an axial suction coupling 101 disposed between opposed spliced ends of tubing 30. In one embodiment, the coupling 21 enables the device 28 to fully rotate through 360 degrees relative to axis A, and axial suction coupling 101 is provided to enable tubing 30 to fully rotate through 360 degrees relative to axis B, where axis B is different than axis A. In this manner, device 28 is provided with multiple degrees of freedom that minimize tangling of tubing 30 and user fatigue.

The suction coupling 21 includes the male flange 48 (FIG. 2) that couples into the female receptacle 78 (FIG. 2), where tubing joint 46 is orthogonal to male flange 48 and tubing joint 76 is orthogonal to the female receptacle 78. In one embodiment, axial suction coupling 101 includes a first union 102 rotatably coupled and linearly aligned with a second union 104. First union 102 includes a linear tubing joint 106 that is aligned along a central longitudinal axis of first union 102, second union 104, and a tubing joint 108 extending from second union 104. In this regard, axial suction coupling 101 includes linearly aligned tubing joints 106, 108 that are suited for splicing into a section of suction source tubing 30 to enable tubing 30 to rotate about axis B. In one embodiment, first union 102 provides a male component that is received by a female receptacle of second union 104, such that first union 102 is fully rotatable through 360 degrees relative to second union 104 as described below.

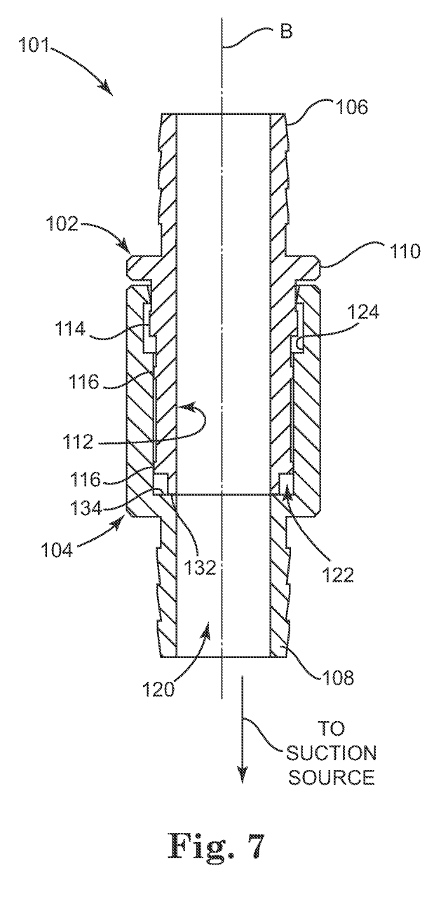

FIG. 7 is a cross-sectional view of axial suction coupling 101 aligned on axis B. In one embodiment, first union 102 includes a base 110, tubing joint 106 extending from base 110, and a male flange 112 extending from base 110 opposite tubing joint 106. In one embodiment, male flange 112 includes a circumferential ridge 114 extending from a mean outside diameter of male flange 112 and one or more circumferential sealing surfaces 116. Sealing surfaces 116 are configured to both stabilize the coupling axis of axial suction coupling 101 and incrementally seal between first union 102 and second union 104. More than two or two or fewer sealing surfaces 116 are also acceptable.

In one embodiment, second union 104 defines a female receptacle 120 extending axially through tubing joint 108 and a channel 122 that defines in part an inside diameter of second union 104. In one embodiment, channel 122 is formed to include an internal peripheral trough 124 that is sized to receive circumferential ridge 114 of male flange 112.

When male flange 112 is coupled with female receptacle 120, sealing surfaces 116 contact a surface of channel 122 and circumferential ridge 114 is retained within internal peripheral trough 124. Suction applied to tubing joint 108 in the direction of suction source draws the first union 102 into second union 104 to provide a rotating coupling having a fluid seal. In particular, a leading end 132 of male flange 112 contacts and seals against a base 134 formed in female receptacle 120.

When suction is applied to axial suction coupling 101, it has been surprisingly discovered that a liquid seal is formed between first union 102 and second union 104 without the aid of O-rings or other added seals or washers. Without being bound to this theory, it is believed that the suction draws the male flange 112 into engagement with the female receptacle 120 in a manner that limits the leaking of fluid from axial suction coupling 101 while permitting first union 102 to fully rotate relative to second union 104.

In one embodiment, axial suction coupling 101 is oriented as shown in FIG. 7 such that the liquid drawn into the coupling 101 first flows through the first union 102 and then flows through the second union 104. In this manner, the coupling 101 is oriented to minimize the possibility that the liquid under suction will become entrapped between the first and second unions 102, 104, which can be undesirable when the liquid is saliva or other body fluids. Other orientations for coupling 101 are within the scope of this disclosure.

Axial suction coupling 101 is formed from materials suitable to the desired end use, including metals or plastics. Examples of suitable plastics include thermoplastic Acetal, nylon, nylon 6, nylon 6,6, polyetherimide, and polyolefins such as high density polyethylene, polypropylene, polyester, and acrylonitrile-butadiene-styrene (ABS). In one embodiment, suction coupling 101 is fabricated from Acetal as it has been discovered that Acetal provides a desired level of surface lubricity that enables easy rotation of first union 102 relative to second union 104.

Suction assemblies have been described having a suction coupling that enables a suction device to be moved independently relative to the tubing extending from the device to a suction source. The suction couplings described above reduce the fatigue of an operator by making it easier to move the suction device relative to the tubing connected to the suction source. In this regard, the relatively inflexible and durable tubing connected to some suction sources need not be moved or flexed when moving the suction device. The suction coupling enables a full range of motion of the suction device in a 360 degree arc relative to the tubing connected to the suction source.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific amniotomy devices discussed herein. Therefore, it is intended that this invention be limited only by the claims and the equivalents thereof.

What is claimed is:

1. A suction coupling comprising:
a first union coupled to a second union, the first union comprising a first tubing joint extending from a side of the first union and a male flange extending from an end of the first union, the second union comprising a second tubing joint extending from a side of the second union and defining a female receptacle formed in an open end of the second union, the male flange rotatably coupled with the female receptacle;
wherein when suction is applied to the second union, the first union forms a liquid seal relative to the second union.

2. The suction coupling of claim 1, wherein the first tubing joint is coupled to a suction device and the second tubing joint is coupled to a suction source such that the suction from the suction source forces the male flange into the female receptacle.

3. The suction coupling of claim 1, wherein the first tubing joint is linearly aligned on an axis with the male flange and the second tubing joint is linearly aligned on an axis with the female receptacle.

4. The suction coupling of claim 1, wherein the first tubing joint is orthogonal to an axis of the male flange and the second tubing joint is orthogonal to an axis of the female receptacle.

5. The suction coupling of claim 1, wherein the male flange comprises a substantially cylindrical flange including a base attached to the end of the first union and a leading end separated from the base and including a circumferential ridge configured to frictionally couple with the female receptacle.

6. The suction coupling of claim 5, wherein the male flange includes an O-ring disposed about the base adjacent to the end of the first union.

7. The suction coupling of claim 5, wherein female receptacle defines a substantially cylindrical channel extending from a circumferential base formed inside the second union to the open end of the second union, the cylindrical channel defining an internal peripheral trough formed adjacent to the circumferential base and configured to receive the circumferential ridge of the male flange.

8. The suction coupling of claim 7, wherein the cylindrical channel of the female receptacle defines a recessed peripheral sealing surface adjacent to the open end of the second housing and configured to sealingly couple with the O-ring.

9. The suction coupling of claim 8, wherein the circumferential ridge of the male flange is rotatably maintained within the internal peripheral trough of the female receptacle, and the recessed peripheral sealing surface of the female receptacle forms a liquid seal with the O-ring.

10. A suction coupling comprising:
a first union comprising a first tubing joint in fluid communication with a male flange extending from an end of the first union, the male flange including a circumferential seal disposed at a base and a circumferential ridge adjacent to a leading end of the male flange; and
a second union comprising a second tubing joint in fluid communication with a female receptacle formed in an open end of the second union, the female receptacle defining an internal circumferential sealing surface formed adjacent to the open end, a circumferential base formed inside the female receptacle between the internal circumferential sealing surface and the tubing joint, and a peripheral trough formed adjacent to the circumferential base;
wherein the circumferential ridge of the male flange is rotatably disposed within the peripheral trough of the female receptacle and the circumferential sealing surface of the female receptacle seals against the circumferential seal of the male flange.

11. The suction coupling of claim 10, wherein the circumferential ridge of the male flange is rotatably disposed within the peripheral trough of the female receptacle and configured to prevent removal of the male flange from the female receptacle.

12. The suction coupling of claim 10, wherein the male flange comprises an O-ring disposed about the base adjacent to the end of the first union.

13. The suction coupling of claim 10, wherein the first union rotates relative to the second union about an axis of rotation that is coaxial with the second tubing joint.

14. The suction coupling of claim 10, wherein when suction is applied to the second union, the first union is forced against the second union.

15. A suction coupling system comprising:
a handheld suction device;
a first union comprising a first tubing joint in fluid communication with the handheld suction device and a male flange that extends from an end of the first union, the male flange including a circumferential seal disposed at a base and a circumferential ridge adjacent to a leading end of the male flange;
a second union comprising a second tubing joint in fluid communication with a female receptacle formed in an open end of the second union, the female receptacle defining an internal circumferential sealing surface formed adjacent to the open end, a circumferential base formed inside the female receptacle between the internal circumferential sealing surface and the tubing joint, and a peripheral trough formed adjacent to the circumferential base; and
suction source tubing in fluid communication with the second tubing joint;
wherein the circumferential ridge of the male flange is rotatably disposed within the peripheral trough of the female receptacle and the circumferential sealing surface of the female receptacle seals against the circumferential seal of the male flange.

16. The suction coupling system of claim 15, further comprising:
an axial suction coupling disposed between opposing ends spliced into the suction source tubing;
wherein the first union rotates relative to the second union about a first axis and the axial suction coupling is configured to enable the suction source tubing to rotate about a second axis different from the first axis.

17. The suction coupling system of claim 16, wherein the first axis is substantially orthogonal to the second axis.

18. The suction coupling system of claim 16, wherein the axial suction coupling comprises a first axial union coupled to a second axial union, the first axial union comprising a first tubing joint coupled to the suction source tubing and a male flange extending from an end of the first axial union, the second axial union comprising a second tubing joint coupled to tubing communication with the suction source and defining a female receptacle formed in an open end of the second axial union, the male flange rotatably coupled with the female receptacle.

19. The suction coupling system of claim 18, wherein when suction is applied to the second union, the first union forms a liquid seal relative to the second union and the first axial union forms a liquid seal relative to the second axial union.

20. The suction coupling system of claim 18, wherein the first union is fully rotatable through 360 degrees relative to the second union and the first axial union is fully rotatable through 360 degrees relative to the second axial union.
